(19) United States
(12) Patent Application Publication
(10) Pub. No.: US 2025/0131459 A1
(43) Pub. Date: Apr. 24, 2025

(54) SYSTEM AND METHOD FOR CONTROLLING PRODUCT ALLOCATION IN RESPONSE TO MARKET VARIATIONS

(71) Applicant: Walmart Apollo, LLC, Bentonville, AR (US)

(72) Inventors: Suprit Saha, Bengaluru (IN); Ashwini Chandrashekharaiah, Bengaluru (IN); Ravishankar Balasubramanian, Bengaluru (IN)

(21) Appl. No.: 18/490,648

(22) Filed: Oct. 19, 2023

(51) Int. Cl. G06Q 30/0201

(52) U.S. Cl. CPC G06Q 30/0201

(57) ABSTRACT

Systems and methods for controlling product allocation in response to market variations are disclosed. In some embodiments, a disclosed method includes: obtaining, from the database, the historical data, the historical data associated with market performance of the first product, identifying a first anomaly in the historical data of the first product, the first anomaly being a deviation in the market performance of the first product, linking a plurality of causal attributes to the first anomaly, generating a plurality of causal estimation values, each of the plurality of causal estimate values being associated with each of the plurality of causal attribute, and identifying a second product based on the plurality of causal estimation values, the second product being different than the first product.

### TECHNICAL FIELD

This application relates generally to managing retail products and, more particularly, to systems and methods for controlling product allocation in response to market variations.

### BACKGROUND

The variations or deviations in the sale of products is an important metric for a retailer to understand. Retail sales of products vary dramatically over time. It is crucial for retailers to evaluate the sales of products over time to identify how the product is performing in the market. For example, retailers may view and analyze various business metrics to determine how a product is performing in the market. Products may have deviations in the marketplace resulting in a decrease in sales. Retailers that are unable to understand these deviations cannot act upon the deviations resulting in potential loss of revenue and/or market share.

Retailers that are unable to understand the causes of the deviations may not be able to correct the deviation or prevent future deviations. Further, failure to determine and properly analyze the factors that caused the deviation can result in similar products also deviating, which may result in further market share loss and/or loss in overall revenue. More importantly, failure to identify and account for factors that cause deviations can result in improper course correction leading to further declining performances.

### SUMMARY

The embodiments described herein are directed to systems and methods for controlling product allocation in response to market variations.

In various embodiments, a system including a database storing historical data associated with a first product, a computing device comprising at least one processor in communication with the database, the computing device being configured to obtain, from the database, the historical data, the historical data associated with market performance of the first product, identify a first anomaly in the historical data of the first product, the first anomaly being a deviation in the market performance of the first product, link a plurality of causal attributes to the first anomaly, generate a plurality of causal estimation values, each of the plurality of causal estimate values being associated with each of the plurality of causal attribute, and identify a second product based on the plurality of causal estimation values, the second product being different than the first product.

In some embodiments, the computing device is further configured to generate a plurality of causal refutal values, each of the plurality of causal refutal values being associated with each of the plurality of causal estimating values and each of the plurality of causal attributes, filter the plurality of causal attributes based on a comparison of each of the plurality of causal refutal values to a predetermined refutal threshold to generate a plurality of filtered causal attributes, and rank the plurality of filtered causal attributes based on their respective plurality of causal estimation values.

In some embodiments, the computing device is further configured to compare the historical data to a predetermined threshold to identify the first anomaly, and generate an anomaly score based on the comparison.

In some embodiments, the computing device is further configured to compare the anomaly score to a predetermined anomaly threshold, and transform the anomaly score to a binary representation based on the comparison of the anomaly score to the predetermined anomaly threshold.

In some embodiments, the computing device is further configured to retrieve, from the database, a plurality of products, generate a ranking of a plurality of causal attributes of each of the plurality of products, and compare the ranking of the plurality causal attributes for each of the plurality of products to one another, and generate a plurality of similar products based on the comparison, the plurality of similar products being a subset of the plurality of products, each similar product in the plurality of similar products having an identical ranking of causal attributes.

In some embodiments, the computing device is further configured to render, on a user interface, at least one insight related to one causal attribute of the plurality of causal attributes, the insight including textual data linking the one causal attribute to the first anomaly.

In some embodiments, the computing device is further configured to render, on a user interface, a selection matrix configured to receive an input from a user, the selection matrix including a selection of the plurality of causal attributes, and in response to the input from the user, generate at least one insight related to one causal attribute of the plurality of causal attributes, the insight including textual data linking the one causal attribute to the first anomaly.

In some embodiments, the computing device is further configured to render, on a user interface, an interactive graphic including the first anomaly, in response to an input from a user, modify the interactive graphic to include a second deviation, aggregate the first anomaly and the second anomaly to create a set of anomalies, and link the plurality of causal attributes to the set of anomalies.

In some embodiments, the plurality of causal estimation values are generated using double machine learning.

In some embodiments, the plurality of causal attributes are linked to the first anomaly using a Non-combinatorial Optimization via Trace Exponential and Augmented Lagrangian for Structure learning algorithm

In various embodiments, a computer-implemented method is disclosed. The computer-implemented method includes obtaining, from a database, historical data, the historical data associated with market performance of the first product, identifying a first anomaly in the historical data of the first product, the first anomaly being a deviation in the market performance of the first product, linking a plurality of causal attributes to the first anomaly, generating a plurality of causal estimation values, each of the plurality of causal estimate values being associated with each of the plurality of causal attribute, and identifying a second product based on the plurality of causal estimation values, the second product being different than the first product.

In some embodiments, the method further comprises generating a plurality of causal refutal values, each of the plurality of causal refutal values being associated with each of the plurality of causal estimating values and each of the plurality of causal attributes, filtering the plurality of causal attributes based on a comparison of each of the plurality of causal refutal values to a predetermined refutal threshold to generate a plurality of filtered causal attributes, and ranking the plurality of filtered causal attributes based on their respective plurality of causal estimation values.

In some embodiments, the method further comprises comparing the historical data to a predetermined threshold to identify the first anomaly, and generating an anomaly score based on the comparison.

In some embodiments, the method further comprises comparing the anomaly score to a predetermined anomaly threshold, and transforming the anomaly score to a binary representation based on the comparison of the anomaly score to the predetermined anomaly threshold.

In some embodiments, the method further comprises retrieving, from the database, a plurality of products, generating a ranking of a plurality of causal attributes of each of the plurality of products, comparing the ranking of the plurality causal attributes for each of the plurality of products to one another, and generating a plurality of similar products based on the comparison, the plurality of similar products being a subset of the plurality of products, each similar product in the plurality of similar products having an identical ranking of causal attributes.

In some embodiments, the method further comprises rendering, on a user interface, at least one insight related to one causal attribute of the plurality of causal attributes, the insight including textual data linking the one causal attribute to the first anomaly.

In some embodiments, the method further comprises rendering, on a user interface, a selection matrix configured to receive an input from a user, the selection matrix including a selection of the plurality of causal attributes, and in response to the input from the user, generating at least one insight related to one causal attribute of the plurality of causal attributes, the insight including textual data linking the one causal attribute to the first anomaly.

In some embodiments, the method further comprises rendering, on a user interface, an interactive graphic including the first anomaly, in response to an input from a user, modifying the interactive graphic to include a second deviation, aggregating the first anomaly and the second anomaly to create a set of anomalies, and linking the plurality of causal attributes to the set of anomalies.

In some embodiments, the plurality of causal attributes are linked to the first anomaly using a Non-combinatorial Optimization via Trace Exponential and Augmented Lagrangian for Structure learning algorithm

In various embodiments, a non-transitory computer readable medium having instructions stored thereon is disclosed. The instructions, when executed by at least one processor, cause at least one device to perform operations including: obtaining, from a database, historical data, the historical data associated with market performance of the first product, identifying a first anomaly in the historical data of the first product, the first anomaly being a deviation in the market performance of the first product, linking a plurality of causal attributes to the first anomaly, generating a plurality of causal estimation values, each of the plurality of causal estimate values being associated with each of the plurality of causal attribute, and identifying a second product based on the plurality of causal estimation values, the second product being different than the first product.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to control product allocation in response to market variations, in accordance with some embodiments of the present teaching.

FIG. 2 is a block diagram of a causal analysis generator, in accordance with some embodiments of the present teaching.

FIG. 3 is a block diagram of a system for controlling product allocation in response to market variations, in accordance with some embodiments of the present teaching.

FIG. 4 is a flow diagram of an anomaly engine, in accordance with some embodiments of the present teaching.

FIG. 5 is a flow diagram of the anomaly engine of FIG. 4, in accordance with some embodiments of the present teaching.

FIG. 6 illustrates a plurality of attributes and anomalies, in accordance with some embodiments of the present teaching.

FIG. 7 is a flow diagram of a causal attribution engine, in accordance with some embodiments of the present teaching.

FIG. 8 illustrates a plurality of graphical representations of causal estimation values (E) and a refutal p-values (R), in accordance with some embodiments of the present teaching.

FIG. 9 illustrates generation of linkage map, in accordance with some embodiments of the present teaching.

FIG. 10 is a flow diagram of causal attribution engine ranking a plurality of attributes, in accordance with some embodiments of the present teaching.

FIG. 11 illustrates clustering of similar product categories based on attributes, in accordance with some embodiments of the present teaching.

FIGS. 12A-12F illustrate a user interface for controlling product allocation in response to market variations, in accordance with some embodiments of the present teaching.

FIG. 13 is a flow diagram for controlling marking variations, in accordance with some embodiments of the present teaching.

FIG. 14 is a flowchart illustrating an exemplary method for controlling product allocation in response to market variations, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for controlling product allocation in response to market variations through the processing of a variety of information from a multitude of sources. In some embodiments, the systems and methods utilize models (e.g., machine learning models) to enhance the control over information provided to users in order to provide personalized information that is more relevant to the user. The systems and methods provided herein may be used to evaluate the performance of a product sold by a retailer. For example, the systems and method provided herein may determine deviations in the performance of a product and may further determine factors that caused the deviation. The systems and methods may then provide potential actions and/or strategies to address the deviation and/or prevent future deviations.

In some embodiments, the systems and methods provided herein provide analysis of factors that caused the deviation. For example, using models (e.g., machine learning models), the systems and methods provided herein may determine the causes of the deviations. In some embodiments, using models, the systems and methods provided herein may provide actions and tasks that the user may undertake to address the deviation and improve performance of the product. In some embodiments, the systems and methods provided herein identifies products similar to the deviated product to allow the user to address the performance of multiple products.

One goal of the present teaching is to determine causes for the deviation in the performance of product and provide insights and actions for retailers based on the determined causes. In some embodiments, a disclosed system utilizes determination of causal factors associated with a deviation in the performance of a product to provide insights and actions for a user to undertake. The system can find similar products that may have a deviation or may deviate in the future to allow the user to proactively manage the product.

In some embodiments, the system allows for the control of retail products (e.g., allocation). The system may include an anomaly (e.g., deviation) detection system (e.g., anomaly engine) that applies a series of models (e.g., machine learning anomaly detection models) to sales data relative to products being sold through a retailer to identify at least one anomaly relative to a threshold for sales over time of a category of products and/or one or more particular products. A causal attribution engine may be provided that is configured to identify casual factors associated with the identified anomaly. In some embodiments, a causal attribution engine includes a set of models that obtain and prioritize possible causes for the detected anomaly. The causal attribution engine may employ one or more models to analyze historical data to determine a plurality of casual factors associated with the anomaly. In some embodiments, the causal attribution engine is configured to rank and prioritize the causal factors to provide the user with the causal factors having the greatest impact on the performance of the product. This allows the user to address the causal factors that may remediate or prevent the anomaly.

In some embodiments, the causal attribution engine determines causal factors that are predicted to have been factors in causing the variation in sales of products within a category of products, and applies a set of models to generate relevancy scores (e.g., causal estimate values) associated with the causal factors. The relevancy scores may indicate the degree to which the causal factor caused the anomaly. For example, a causal factor with a higher relevancy score may have a greater association with causing the anomaly than a causal factor with a lower relevancy score. In some embodiments, the causal attribution engine prioritize the causal factors based on the relevancy scores.

In some embodiments, the systems and methods of controlling product allocation in response to market variations provide a user interface. The user interface may allow a user to view the detected anomalies and the generated causal factors. In some embodiments, the user interface allows the user to manually select additional anomalies for the system to incorporate into its analysis. Further, the user interface may allow a user to view specific causes for the anomalies. The user interface may present to a user one or more graphics representing changes or selections of one or more causal factors. The user interface may provide to the user, insights based on the causal factors that are indicated to have a greater effect on the anomaly.

In some embodiments, the user interface provides the user identified similar products that are associated with the causal factors. The similar products may also have anomalies in their market performance or may be predicted to have anomalies in their market performance. This allows the user to view other products associated with the causal factors that caused the anomaly or deviation in the market performance of the initial product.

Furthermore, in the following, various embodiments are described with respect to methods and systems for controlling product allocation in response to market variations are disclosed. In some embodiments, a disclosed method includes: obtaining, from a database, historical data, the historical data associated with market performance of the first product, identifying a first anomaly in the historical data of the first product, the first anomaly being a deviation in the market performance of the first product, linking a plurality of causal attributes to the first anomaly, generating a plurality of causal estimation values, each of the plurality of causal estimate values being associated with each of the plurality of causal attribute, and identifying a second product based on the plurality of causal estimation values, the second product being different than the first product.

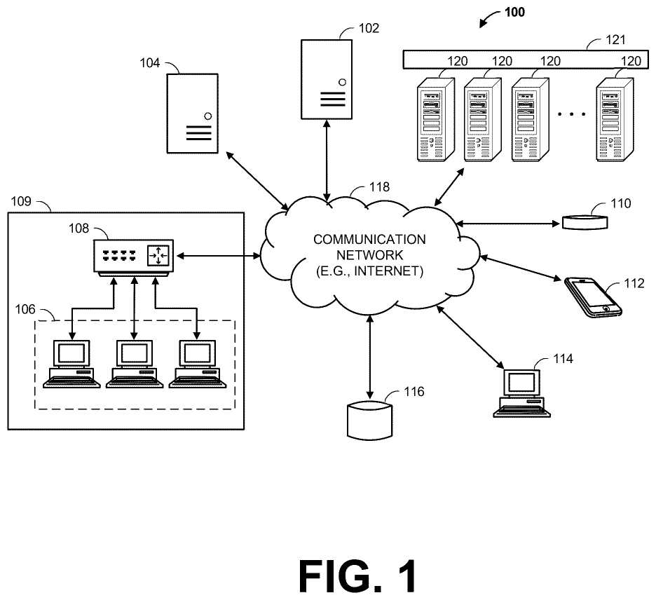

Turning to the drawings, FIG. 1 is a network environment 100 configured to control product allocation in response to market variations, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, causal anomaly generator or CA generator 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The CA generator 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the CA generator 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the CA generator 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the CA generator 102, the processing devices 120, and/or the web server 104 are operated by a retailer. The multiple user computing devices 110, 112, 114 may be operated by customers or advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the CA generator 102 over the communication network 118. The workstation(s) 106 may send data to, and receive data from, the CA generator 102. For example, the workstation(s) 106 may transmit data identifying items purchased by a customer at the store 109 to the CA generator 102.

Although FIG. 1 illustrates three user computing devices 110, 112, 114, the network environment 100 can include any number of user computing devices 110, 112, 114. Similarly, the network environment 100 can include any number of the CA generator 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view a user interface for viewing and interacting with anomalies associated with a product and causal factors associated with the anomalies. The website may capture these activities as user session data, and transmit the user session data to the CA generator 102 over the communication network 118. The website, via the user interface, may also allow the user to view business metrics associated with the product or view similar products. The website may also allow a user to view causal factors based on specific categories. In some examples, the web server 104 transmits user data to the CA generator 102. The user data may include data associated with the user's interaction with the website via the user interface.

In some examples, a user (e.g., a retailer) may use one of the user computing devices 110, 112, 114 to view, control, and predict various business metrics associated with one or more products and/or one or more product categories. The user may use a user interface to view, control, and analyze the various business metrics associated with one or more products via web server 104. The user may, via the web browser or the user interface, view business metrics associated with one or more products, view and manage causal factors associated with anomalies (e.g., deviations) associated with the one or more products, view similar products that may have anomalies, view actionable tasks for managing anomalies associated with the one or more products. The website may capture at least some of these activities as user data or product management data. The web server 104 may transmit the user data to the CA generator 102 over the communication network 118, and/or store the user data to the database 116. In some embodiments, product management data includes one or more of anomalies associated with performance of the product, causal factors associated with the anomalies, and similar products that are deemed similar based on related causal factors.

In some embodiments, the web server 104 transmits a product management request to the CA generator 102, e.g. upon a selection of a user to view and manage business metrics and market variations associated with a product. For example, the product management request may be sent based on the desire of a user to view and manage causal factors associated with deviations in the performance of a product and identify similar products that may have deviations based on the causal factors. Without the causal factors, the user may not have adequate information to address the causes of the anomalies associated with the performance of the product resulting in decline in business metrics (e.g., loss of revenue, loss of market share). The product management request may be sent standalone or together with other related data of the website. In some examples, the product management request may carry or indicate user data.

In some examples, the CA generator 102 may execute one or more models (e.g., algorithms), such as a machine learning model, deep learning model, statistical model, etc., to determine causal factors associated with the anomaly and/or identify similar products that may have anomalies. The CA generator 102 may identify causal factors, generate the quantifiable impact of each causal factor, and identify similar products based on the causal factors. In some embodiments, multiple models are executed by the CA generator 102 to identify anomalies, identify causal factors associated with the anomalies, generate prioritizations for the causal factors, and identify similar products based on the causal factors. For example, the CA generator 102 may execute a first model to detect anomalies, may execute a second model to detect causal factors, may execute a third model to prioritize the causal factors, and execute a fourth model to identify similar products.

The CA generator 102 is further operable to communicate with the database 116 over the communication network 118. For example, the CA generator 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the CA generator 102, in some examples, the database 116 can be a local storage device, such as a hard drive, a non-volatile memory, or a USB stick. The CA generator 102 may store historical data, business metrics, user data, or data associated with one or more products and/or one or more product categories received from the web server 104 in the database 116. The CA generator 102 may receive business metrics associated with one or more products and/or one or more product categories. In some embodiments, the business metrics include historical data associated with the one or more products and/or one or more product categories. The CA generator 102 may also receive from the web server 104 user session data identifying events associated with browsing sessions, and may store the user session data in the database 116. Database 116 may be coupled to a computing device.

In some embodiments, the web server 104 transmits a model training request to the CA generator 102. Upon the model training request, the CA generator 102 may retrieve, e.g. from the database 116, historical data associated with performance of the product. The CA generator 102 may train one or more models using the historical data of the product. The one or more models may be trained to identify anomalies in the performance of a product, generate causal factors associated with the anomalies, and identify similar products based on the causal factors. In some embodiments, the outputs from the model may be used to refine and train the model. For example, one or more models may be trained using historical data (e.g., past performance of a product) and may identify an anomaly in the performance of the product. The identified anomalies may be compared to actual anomalies in the performance of the product to generate a comparison value. The comparison value may be inputted into the one or more models to refine the one or more models to make the one or more models more accurate.

The models, when executed by the CA generator 102, allow the CA generator 102 to generate product management data. In some examples, the CA generator 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the CA generator 102 may generate product management data. The CA generator 102 may provide a user interface to allow a user to interact with the generated product management data. For example, the user interface may allow a user to view and adjust detected anomalies of the product management data, view and adjust one or more causal factors associated with the anomalies, and/or view products that are similar based on the causal factors.

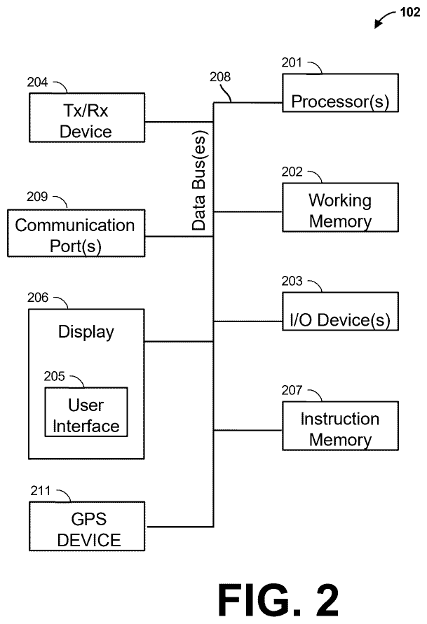

FIG. 2 illustrates a block diagram of a CA generator 102 of FIG. 1, in accordance with some embodiments of the present teaching. In some embodiments, each of the CA generator 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the CA generator 102 can be combined, omitted, and/or replicated. In addition, it will be appreciated that additional elements other than those illustrated in FIG. 2 can be added to the CA generator 102.

As shown in FIG. 2, the CA generator 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the CA generator 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the CA generator 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NOSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the CA generator 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the CA generator 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the CA generator 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the CA generator 102 and/or the web server 104. For example, the user interface 205 can be a user interface for an application of a network environment operator that allows a customer to view and interact with the product management data generated by the CA generator 102. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the CA generator 102 may determine a local geographical area (e.g., town, city, state, etc.) of its position.

In some embodiments, the CA generator 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the CA generator 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data includes historic data of recipients and their association with known companies, predefined profiles of types of recipients, predefined profiles of known preferences of information, predefined associations of responsibilities to types of recipients and other such information. Further, the training data includes historic sales data (e.g., quantities of products sold, pricing, pricing adjustments, etc.), typically for one or more years, in association with historic inventory information, historic marketing information, and other such information. Some embodiments further include historic anomaly detected events in relation to known historic causes of those historic anomaly events. The training data additionally includes historic information about different information supplied to and/or accessed by different users corresponding to thousands or more products from hundreds of different suppliers and/or manufactures and sold from multiple different retail stores distributed over multiple different geographic areas. Further, the training systems is configured to receive feedback information at least through the graphical user interface corresponding to actions by the different recipients interfacing with the respective graphical user interface based on the rendered customized anomaly notification information. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained anomaly detection models, retrained contextual models, retrained causal inference and determination models, retrained attribution prioritization models, retrained forecast models, retrained personalization models, and/or other retrained machine learning algorithms that improve performance over time and enhance the identification of anomalies, and the identification of information that is more relevant to the invented recipient.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system is configured to receive feedback information through the graphical user interface corresponding to actions by the recipient interfacing with the graphical user interface based on the rendered first customized anomaly notification information, and implement retraining based on the feedback information.

The above and below description includes descriptions of embodiments implementing and/or utilizing trained machine learning models and/or neural networks. In some embodiments, the neural network, machine learning models and/or machine learning algorithms may include, but are not limited to, Heuristics, Univariate based techniques, Multivariate, control limit, isolation forest and LOF-ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

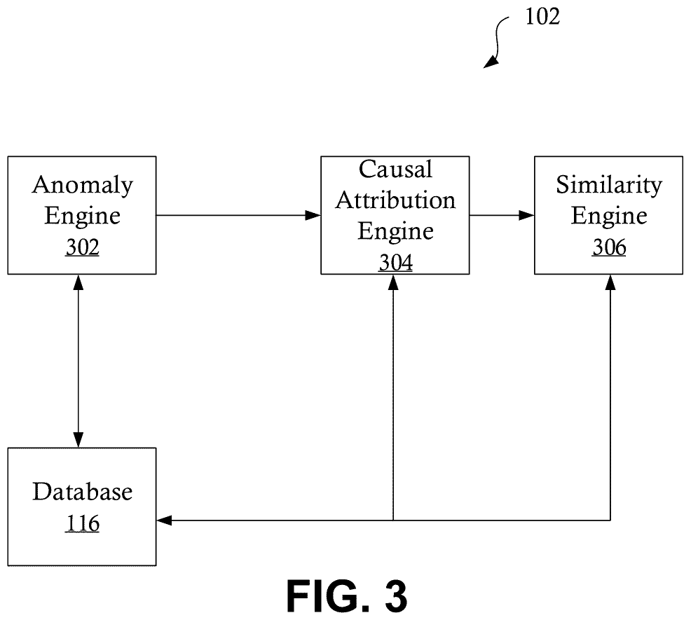

FIG. 3 is a block diagram illustrating various portions of a system for generating product management data, e.g. the system shown in the network environment 100 of FIG. 1, in accordance with some embodiments of the present teaching. As indicated in FIG. 3, the CA generator 102 may receive historical data from database 116. The historical data may include user data identifying, for example, a retailer, and product data. The product data may include past performance data associated with a product. For example, the product data may include a baseline performance, and deviations from the baseline above a threshold may indicate anomalies. In some embodiments, the baseline is depending on season or holiday periods within a calendar year. For example, the baseline performance during the Christmas holiday season may be higher than during the Fall season. By way of another example, the baseline performance during Thanksgiving for toys category may be lower than the sales of previous year's Thanksgiving season. Extreme deviations from the baseline may be identified as an anomaly.

In some embodiments, the CA generator 102 includes anomaly engine 302, causal attribution engine 304, and similarity engine 306. Anomaly engine 302 may be configured to analyze historical data associated with a product. The historical data may include historical performance data associated with a product. The historical performance data may be the performance of a product over a predetermined period of time. In some embodiments, the predetermined period of time is greater than one year. For example, the predetermined period may be two years. The predetermined time period may be from one year to ten years, three years to five years, or greater than ten years. The predetermined period of time may be greater than a year to include multiple iterations of each season or holiday period within a calendar year (e.g., summer, Easter, spring, Thanksgiving, Christmas, etc.). Inclusion of multiple iterations of each season may assist in training the one or models to detect deviations from the baseline. For example, the predetermined period being less than a year may identify the increased performance of a product during the Christmas holiday season as an anomaly. However, the increased performance of the product during the Christmas holiday season may occur multiple years and thus is not an anomaly.

In some embodiments, the product data (e.g., product performance) is compared to a threshold variation. For example, the product data may include performance, inventory, sales, revenue, delivery metrics, etc., and the product data may vary over time. The varying of the product data may be compared to a threshold variation to determine a extremes (e.g., large deviations). A deviation that is greater than the threshold variation may be identified as an anomaly.

CA generator 102 may include causal attribution engine 304. Causal attribution engine 304 may be configured to receive the identified anomalies from anomaly engine 302 and generate or identify causal factors. In some embodiments, causal attribution engine 304 is configured to perform on a root causal analysis based on the identified anomalies. The root causal analysis may indicate one or more factors or attributes that caused the anomalies to occur.

The causal factors may be factors or attributes that are associated with the cause of each anomaly. In some embodiments, anomaly engine 302 is configured to transmit the identified anomalies (e.g., anomaly data) to database 116 and causal attribution engine 302 is configured to retrieve the anomaly data from database 116. In some embodiments, anomaly engine 302 transmits the identified anomaly data to causal attribution engine 304 either automatically (e.g., push) or upon request. Causal attribution engine 304 may be configured to generate or identify causal factors (e.g., price, holidays, seasons, items on hand, instock, traited store count, market share, assortment change, etc.), which may be the cause of the anomaly. Causal attribution engine 304 may use one or more models trained via historical data to determine causal factors associated with the one or more anomalies.

In some embodiments, causal attribution engine 304 is configured to generate an estimation of the effect of the causal factor on the anomalies. For example, causal attribution engine 304 may identify a causal factor associated with an anomaly detected by anomaly engine 302 and causal attribution engine 304 may generate a causal estimation value for each causal factor. The causal estimation value may indicate a quantified effect that the causal factor has on the anomaly. In some embodiments, causal attribution engine 304 is configured to rank and prioritize the one or more causal factors based on the causal estimation value. In some embodiments, causal attribution engine 304 is configured to map each causal factor to the causal estimation value and store the mapped causal factors in database 116.

CA generator 102 may include similarity engine 306 configured to cluster and identify similar products to the product associated with the identified anomalies. Similarity engine 306 may identify products within the same category as the product or category associated with the anomaly. In some embodiments, similarity engine 306 identifies one or more products based on the mapped causal factors and clusters one or more products to assist a user in understanding broader causal patterns impacting certain groups of items. Similarity engine 306 may identify similar products that are presented to the user via the user interface and allow a user to proactively adjust business metrics associated with the identified similar products.

Anomaly engine 302 is configured to evaluate extensive amounts of different types of information in identifying anomalies (sometimes referred to as deviations or exceptions) associated with one or more categories of products and/or individual products. Some examples of anomalies are threshold variations in quantities of sales, threshold variations in quantities of sales between two different times, threshold variations in quantities of sales over one or more durations of time, threshold variations in values or dollar amounts of sales of one or more categories of products and/or one or more products of a category over one or more predefined durations of time, threshold variations in a quantity or quantities of one or more categories of products and/or one or more products, and other such anomalies.

In some embodiments, anomaly engine 302 applies a series of machine learning anomaly detection models to product data (e.g., inventory data, sales data relative to products being sold through a retailer, and/or other relevant information) to identify one or more anomalies over a predetermined period of time (e.g., over weeks or days). For example, a series of anomaly detection models can be applied to sales data relative to products being sold through a retailer to identify an anomaly relative to a threshold variation in sales over time of a particular category of products and/or an individual product. Based on the identified anomaly, the CA generator 102 is further configured to provide information to one or more intended recipients regarding the anomaly (e.g., via a user interface). Different potential recipients and/or groups or personas of recipients have different responsibilities, key performance indicators (KPIs), and other such factors. As such, different recipient personas are interested in different details about an anomaly. In some embodiment, anomaly engine 302 identifies one or more anomalies for a product or product category week over week. For example, anomaly engine 302 may identify anomalies for a product or product category by analyzing performance metrics per week to identify which weeks have anomalies or deviations.

In some embodiments, anomaly engine 302 identifies alerts and exceptions through the application of the series of anomaly detection models, such as but not limited to Heuristics, Univariate based techniques, Multivariate, control limit, isolation forest and local outlier factor (LOF)—ensembles, deep learning models such as LSTM-based autoencoders, variational autoencoders, and/or other such machine learning models. In some embodiments, anomaly engine 302 identifies anomaly clustering and/or anomaly patterns. In some embodiments, anomaly engine 302 further applies a set of one or more machine learning clustering models relative to the plurality of different anomalies identified over time. The clustering aids in identifying a relevance of the detected anomalies and/or provide enhanced control over what and when anomaly information is reported, and/or a level of intensity of irregularities are to be highlighted to relevant recipients.

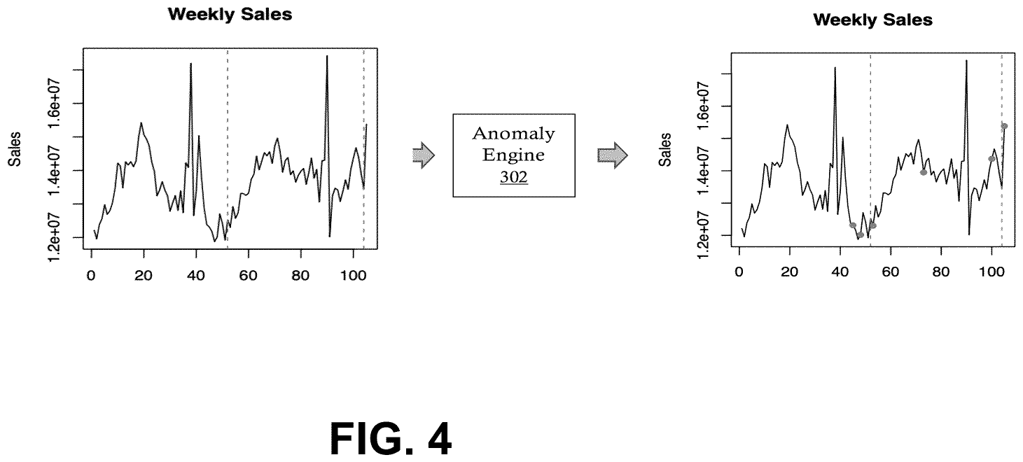

Referring to FIG. 4, anomaly engine 302 is configured to obtain historical data associated with a product or product category. The historical data may include the performance data (e.g., sales or revenue generated) of a product or category over a predetermined period of time (e.g., two years). Anomaly engine 302 may be configured to identify one or more anomalies in the performance of the product or product category. In some embodiments, an anomaly is a deviation from a baseline variation of the performance of the product or product category. Anomaly engine 302 may identify deviations that above a threshold variation. The threshold variation may be determined based on one or more models trained using the historical data of the product or product category.

Anomaly engine 302 may generate an anomaly score for each anomaly identified. The anomaly score may indicate the amount of variation of the identified anomaly. For example, each identified anomaly may be compared to the baseline to quantify the deviation from the baseline. The quantification of the deviation is the anomaly score. In some embodiments, the anomaly score is amount that the anomaly deviates from the threshold variation. The greater that anomaly score the more extreme the anomaly (e.g., the more extreme variation or deviation in the performance of the product or product category).

In some embodiments, anomaly engine 302 generates an anomaly data set including the anomaly scores identified for the product or product category. The anomaly data set may be mapped to the product or product category to which it pertains. In some embodiments, anomaly engine 302 stores the anomaly data set within database 116. The anomaly data set may be added to the historical data and may be used to train one or more models, such as the one or more models used to identify anomalies. Causal attribution engine 304 may retrieve the anomaly data set or the historical data containing the anomaly data set from database 116 or anomaly engine 302. Causal attribution engine 304 may generate or identify causal factors based on the anomaly data set.

In some embodiments, anomaly engine 302 presents, via a user interface, the anomaly scores and/or an indication of the anomalies. For example, anomaly engine 302 may overlay the detected anomalies and their respective anomaly scores on the performance of the product or category to present the overlayed graphic to a user via the user interface. This allows the user to view where the anomalies occurred. As indicated above, anomaly engine 302 may include one or more models trained to identify anomalies in the performance data of a product or product category.

In some embodiments, a user may add an anomaly to the performance data via the user interface. For example, anomaly engine 302 may generate a graphical representation of the performance data. The graphical representation may include a line graph plotting the performance data (e.g., sales, revenue, inventory, etc.) of the product or product category over time. Anomaly engine 302 may generate indicators on the line graph representing each anomaly. In some embodiments, a user may add additional anomalies on the line graph. These additional anomalies may be added to the anomaly data set that may be sent to causal attribution engine 304.

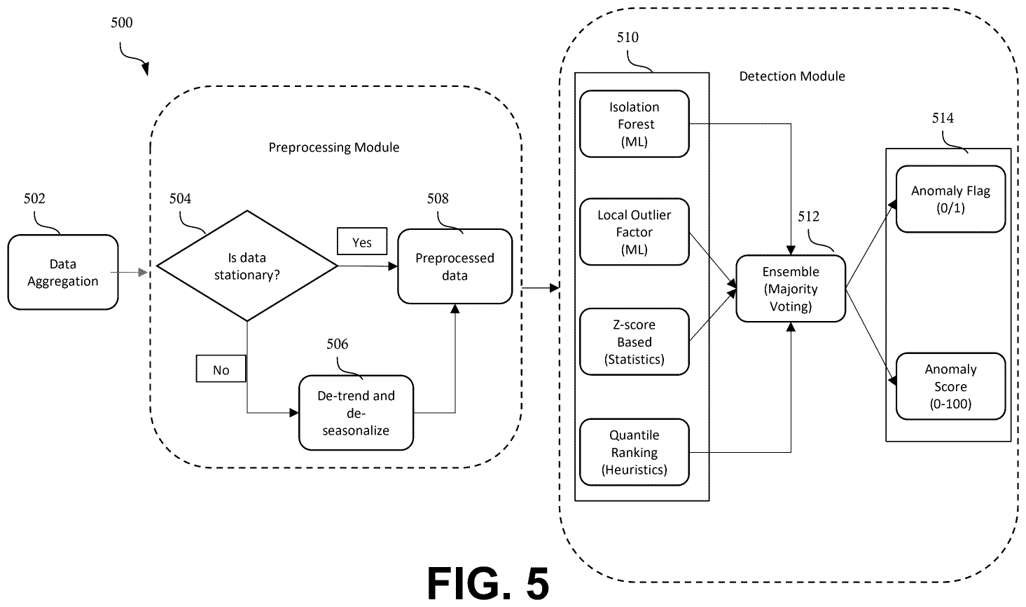

FIG. 5 illustrates a simplified flow diagram of an exemplary process 500 of anomaly detection via anomaly engine 302, in accordance with some embodiments. In step 502, data is aggregated, and anomalies are identified (e.g., at daily, weekly and monthly levels for different item hierarchy levels). In step 504 it is determined whether data is stationary (e.g., perform an augmented Dickey-Fuller (ADF) test to test the stationarity of each input). This attempts to detect seasonal, trend or other such patterns, typically based on historical data. Some embodiments include step 506 where data is detrended and/or de-seasonalized, and the data is preprocessed in step 505. In step 510, the models are trained and/or retrained based on feedback. Multiple anomaly detection models can be leveraged that use some and typically the entire training data. FIG. 5 shows an example of some models that can be applied, however, other anomaly detection machine learning algorithms can be applied. Some embodiments include step 512, where the results of individual models are combined to obtain the final output. In some implementations, for example, for each data point, two values are returned in step 514—anomaly flag (0/1) and anomaly score (0-100).

The evaluation of anomalies are not limited to particular items. Instead, the systems and methods consider categories of products, but further evaluate individual products in identifying anomalies and the causes of anomalies. For example, a detected anomaly relative to a category of “chilled beverages” is further evaluated at one or more sub-categories (e.g., a “mainstream chilled beverages” sub-category, a set of secondary sub-categories of “juices”, “chilled coffees” and “chilled teas”, with a tertiary sub-categories of “black coffee” and “premium tea”). Based on the sub-category evaluations, the system can identify the anomalies at multiple different product hierarchies. Similarly, the system can weigh the effects of different sub-categories in identifying the relevance of effect that a sub-category is having relative to one or more anomalies associated with the category. As a further example, sales patterns can be observed over a period of time (e.g., 2 years), and based on this pattern, the latest dates sales metric is categorized as being an anomaly (exception) or a normal behavior. Some embodiments preform the analysis across different aggregation levels of product hierarchy. Once an anomaly score (e.g., anomaly value) is determined using the models, a weighted ensemble algorithm prioritizes the alert (e.g., based on one or more of a volume of the item or item hierarchy, impact of the exception, direction of the deviation, persistence of the deviation trend, etc.). Once an anomaly is detected, the contextualization provides a reference to describe what the anomaly is. Some embodiments may consider lookback periods of different durations and the current period's metric can be benchmarked against the distribution across the lookback periods. For this benchmarking, in some embodiments, statistical techniques of quantile based filtering and statistical range based prioritization can be performed. This provides an intuitive representation of the anomaly to the user in understanding why it is being called out as an anomaly. Once the anomaly has been detected and referenced the anomaly at product and/or product hierarchy level, some embodiments apply modeling to further drill down to narrower the focus areas that are actionable by the intended recipient. Some embodiments go down to granular analysis, looking at channel level analysis and geographic drill down (e.g., channel level-consider the different channels that are contributing to the overall sales and the channels that are driving the deviation in the sales; store level-looking at regions/stores that are heavily dominating the sales deviation, etc.). Further, some embodiments use of Bollinger Band technique for the channel attribution and hierarchical tree-based techniques through geographic levels for sales drill down.

Some embodiments consider cause-effect attributions based on multiple influencing factors that affect and/or drive one or more metric performances. For example: Time Based-explain if the metric deviations are because of seasonal patterns, or specific events; Geographic drill down-covered as part of identifying where an anomaly occurs; Inventory—if the sales is impacted because of inventory stock outs/low inventory/supply chain issues; Assortment—sales can deviate because of addition/deletion of items/change in modulars—visibility and placement of items in stores; Price—sales impacted by price changes on items; promotions-Planned Promotions that are meant to influence and increase sales, Marketing Promotions; Competitor Information—How the supplier is performing as compared of the average of rest of the competitors; Customer Behavior changes-How market trends and changing customer demographics who are core buyers of the category impact the performance of the category; etc.). In some implementations, different domains of the cause-effect attribution are modeled using different techniques as appropriate.

In some embodiments, anomaly engine 302 is configured to cluster the identified anomalies based on their respective anomaly scores. For example, an identified anomaly having a deviation from a baseline variation that is greater than a predetermined threshold variation may have a higher anomaly score or indicated as high. In some embodiments, the anomaly score is from 0-100. However, the anomaly score may be on any scale to all for comparison and quantification. An identified anomaly having a deviation from a baseline variation that is less than a predetermined threshold variation may have a lower anomaly score or indicated as low. In some embodiments, anomaly engine 302 flags anomalies with an anomaly score greater than a predetermined anomaly threshold. Anomalies that are flagged may be considered extreme and may be marked as extreme. In some embodiments, anomalies that are flagged (e.g., due to their anomaly score being above the predetermined threshold) are marked as 1. In some embodiments, all anomalies that are not flagged (e.g., due to their anomaly score being below the predetermined threshold) are marked as 0. In some embodiments, anomaly engine 302 transforms the anomaly score to a binary representation (e.g., 0 or 1) based on the anomaly score being above the predetermined threshold. For example, an anomaly score being above the predetermined threshold may be flagged and/or transformed to a binary representation of 1. Anomaly engine 302 may store the flagged anomalies and/or the anomaly scores within database 116. In some embodiments, anomaly engine 302 generates an anomaly data set containing each anomaly, it's anomaly score, flagged status, and/or binary representation. The anomaly data set may be stored within database 116.

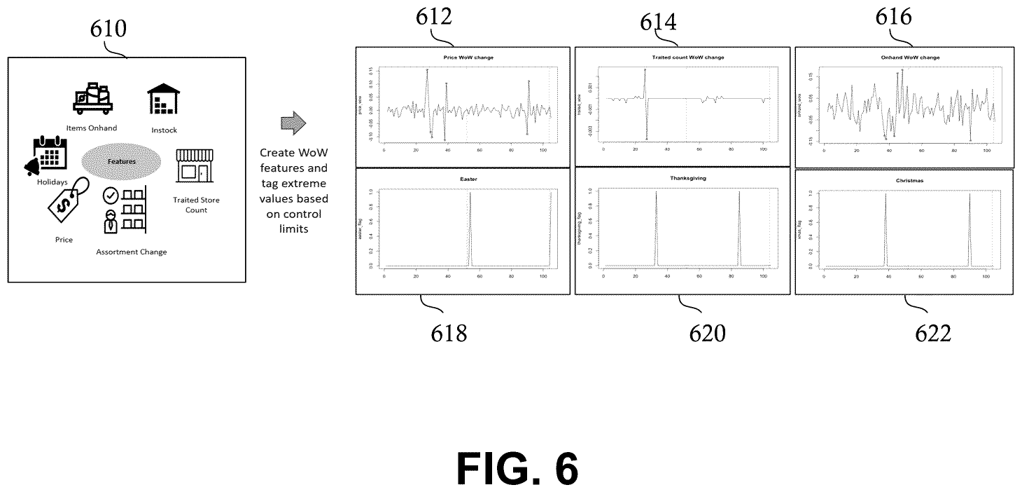

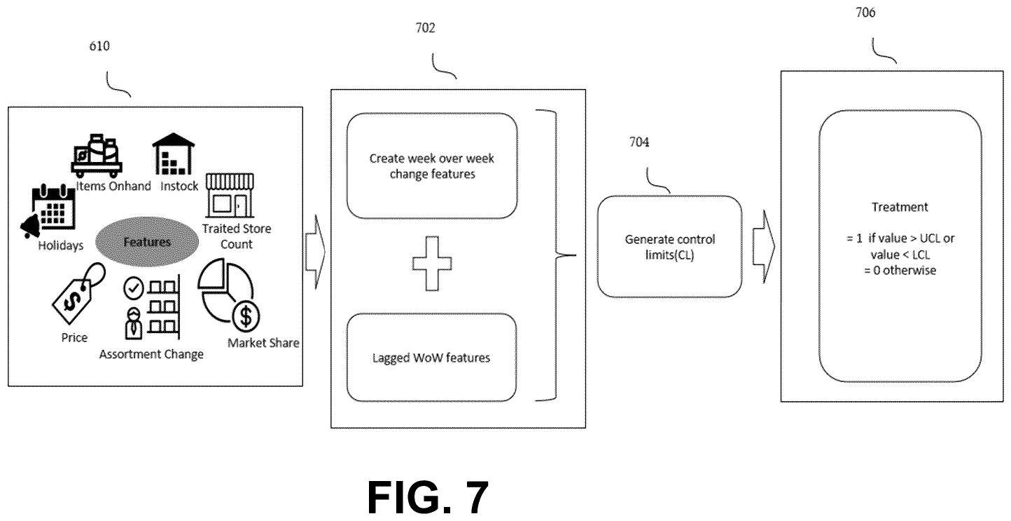

Referring to FIGS. 6-7, causal attribution engine 304 is configured to utilize causal inference to generate causal factors associated with anomalies identified by anomaly engine 302. Causal attribution engine 304 may obtain (e.g., receive or retrieve) the anomaly data set from anomaly engine 302 or database 106. The anomaly data set may include anomalies identified via anomaly engine 302, anomalies identified by the user via the user interface, the anomaly score of each respective anomaly, and/or the flagged/binary representation of each anomaly. In some embodiments, the user may, via the user interface, remove one or more identified anomalies. In some embodiments, causal attribution engine 304 is configured to transform the anomaly score of each anomaly to a binary representation (e.g., 0 or 1). Causal attribution engine 304 may transform each anomaly score for each anomaly that is above the predetermined threshold to 1 and mark all other anomalies as 0. The anomalies marked or flagged as 1 may be marked or identified as extreme anomalies.

In some embodiments, all the anomalies that do not have an anomaly score of 1 are marked as having an anomaly score of 0. The anomalies with an anomaly score of 1 may be clustered together as an anomaly data set and the anomalies with an anomaly score of 0 may be clustered together and not included in the anomaly data set. In some embodiments, only anomalies with an anomaly score of 1 are retrieved and/or transmitted to causal attribution engine 304.

Causal attribution engine 304 may be configured to generate attributes (e.g., factors) associated with each extreme anomaly. For example, for each extreme anomaly, causal attribution engine 304 may identify attributes 610 that are a causal factor for one or more extreme anomalies. Attributes 610 may include causal factors, which may include price, holidays, assortment change, market share, traited stores, inventory, product availability (e.g., onhand). Causal attribution engine 304 may receive data associated with each attribute 610 from one or more sources associated with the retailer and/or a third-party. For example, causal attribution engine 304 may receive inventory or price information from the retailer. In some embodiments, causal attribution engine 304 clusters or groups one or more extreme anomalies and generate attributes associated with the cluster or group of one or more extreme anomalies.

In some embodiments, causal attribution engine 304 is configured to determine the relationship between attributes 610 and one or more extreme anomalies. For example, causal attribution engine 304 is configured to correlate each extreme anomaly to each attribute of attributes 610. In some embodiments, causal attribution engine 304 maps one or more extreme anomalies to each attribute 610. Causal attribution engine 304 may generate one or more graphics to present to the user via the user interface of the mapping of one or more extreme anomalies to each attribute 610. For example, causal attribute engine 304 may map one or more extreme anomalies to price change week over week as illustrated in graphic 612. Causal attribute engine 304 may map one or more extreme anomalies to traited store changes week over week as illustrated in graphic 614. Causal attribution engine 304 may map one or more extreme anomalies to onhand changes week over week as illustrated in graphic 616. Causal attribute engine 304 may map one or more extreme anomalies to one or more holidays such as illustrated in graphic 618 (Easter), graphic 620 (Thanksgiving), and graphic 622 (Christmas). For each graphic 612, 614, 616, 618, 620, 622, causal attribution engine 304 may annotate or remove one or more causal attributes and allows the user to accept or remove the attribute based on user defined thresholds or domain knowledge. For example, a user may define a predetermined attribute threshold for Christmas and causal attribution engine 304 may determine whether the changes in the attribute of Christmas is significant to be considered as a causal factor, 304.

Referring to FIG. 7, causal attribution engine 304, as illustrated in step 702 may generate week over week (WoW) changes for each of attribute 610. In some embodiments, causal attribution engine 304 generates day over day, month over month, or year over year changes for each attribute 610. In some embodiments, the week over week changes are lagged. For example, the week over week changes are based on the historical data (e.g., product data) associated with the one or more products or product categories that the anomalies have been identified for. The historical data may be data associated with the one or more product or product categories that is greater than one day old, greater than five days, greater than one week old, or greater than two weeks old, or greater than two months old. In some embodiments, the performance of the first product is impacted by change in the causal factors that can have a lag of one week or greater than one week.

Causal attribution engine 304 may be configured to identify extreme week over week changes (e.g., extreme high and extreme low) associated with each attribute 610. Causal attribution engine 304 may generate, as illustrated in step 704, control limits associated with each attribute 610. Causal attribution engine 304 may compare the week over week changes of each attribute 610 to each control limit with each attribute 610. The control limits may have an upper control limit (UCL) defining an upper boundary and a lower control limit (LCL) defining a lower boundary. For each attribute 610 that has a week over week change greater than its respective UCL or lower than its respective LCL, causal attribution engine 304, as illustrated in step 706, may map that attribute 610 to a binary representation (e.g., 0 or 1). For example, for each attribute 610 that has a week over week change greater than its respective UCL or less than its respective LCL, causal attribution engine 304 marks the week over week change as extreme and assigns that attribute 610 a value of 1. All other week over week changes for that attribute 610 that are between the LCL and UCL is assigned a value of 0.

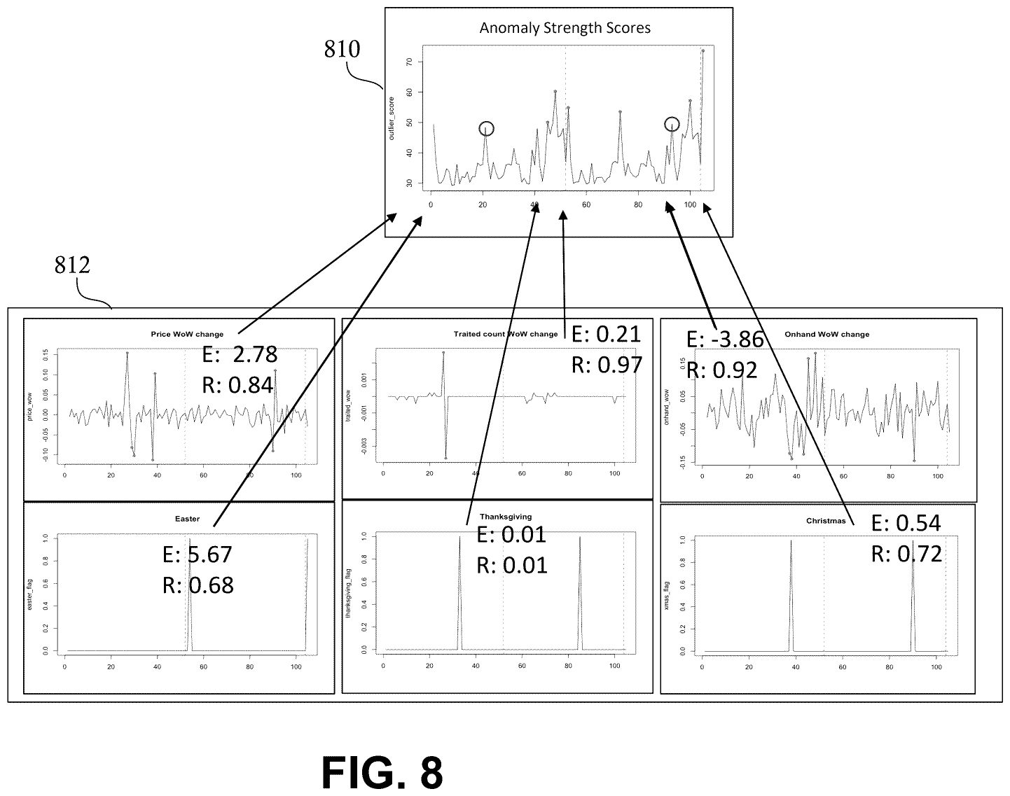

Referring to FIG. 8, causal attribution engine 304 may be configured to generate a causal estimation value (E) and a refutal p-value (R) for each attribute 610. The causal estimate value may indicate the effect that the attribute had on the one or more extreme anomalies. For example, a higher causal estimation value for an attribute indicates that the attribute was a significant causal factor in the one or more extreme anomalies. In other words, a higher causal estimation value for an attribute indicates that the attribute (e.g., price) was a significant cause of the anomaly in the performance of the product or product category.

Causal attribution engine 304 may retrieve and/or obtain a plurality of anomaly scores 810 from anomaly engine 302. Causal attribution engine 304 may generate or identify attributes (e.g., causal factors) based on the plurality of anomaly scores 810. Causal attribution engine 304 may generate a causal estimation value (E) and a refutal p-value (R) for each attribute. Causal attribution engine 304 may generate the causal estimation value (E) and the refutal p-value (R) based on causal inference between the attributes and the one or more extreme anomalies. For example, causal attribution engine 304 may utilize one or more models to generate the causal estimation value (E) and the refutal p-value (R). The one or more models may receive data from one or more third-party databases or sources to generate the causal estimation value (E) and the refutal p-value (R). In some embodiments, causal attribution engine 304 utilizes DoWhy and/or EconML step framework to generate the causal estimation value (E) and the refutal p-value (R) for each attribute. In some embodiments, causal attribution engine 304 utilizes double machine learning to generate the causal effects of each attribute, which are quantified via the E value. The one or more models may estimate heterogenous treatment effects of the attributes from observational data via one or more models (e.g., machine learning models).

In some embodiments, E value refers to a proportional relationship between the attribute and the performance. For ranking purposes, the absolute value of E is considered. For example, a positive E value for the attribute of price indicates that as the price increases, the anomaly value increases indicating more variation in the performance of the product or product category as the price increases. A negative E value for the attribute of onhand (e.g., item in stock) indicates that as the onhead decreases, the anomaly value increases indicating more variation in the performance of the product or product category as the onhand increases.

The refutal p-value (R) indicates the statistical significance of the E value based on statistical analysis. For a refutation test, the p-value R denotes whether the test has found a problem with the estimate. In some embodiments, low R values indicate that E value is not statistically significant and thus the attribute does not have an impact on the cause of the anomaly (e.g., extreme variation in the performance of the product or product category). Attributes with high R values are only considered as possible causal factors. The R value may indicate verification of the validity of the E value using a variety statistical analysis based on the computation of the E value.

As illustrated in FIG. 8, causal attribution engine 304 may retrieve a plurality of anomaly scores 810 associated with the extreme anomalies discussed above. Graphic 812 shows that an E value and an R value is generated for each attribute and mapped to the plurality of anomaly scores 810. The arrows in FIG. 8 represent the level of impact that each attribute, for which an E value and R value were generated, has on the variation in the performance of the product or product category (e.g., an extreme anomaly). In some embodiments, the attribute with the highest value has the most impact on the anomalies and/or performance of the product or product category. Upon generating the E value, causal attribution engine 304 may take the absolute value of the E value to determine the attributes having the greatest impact.

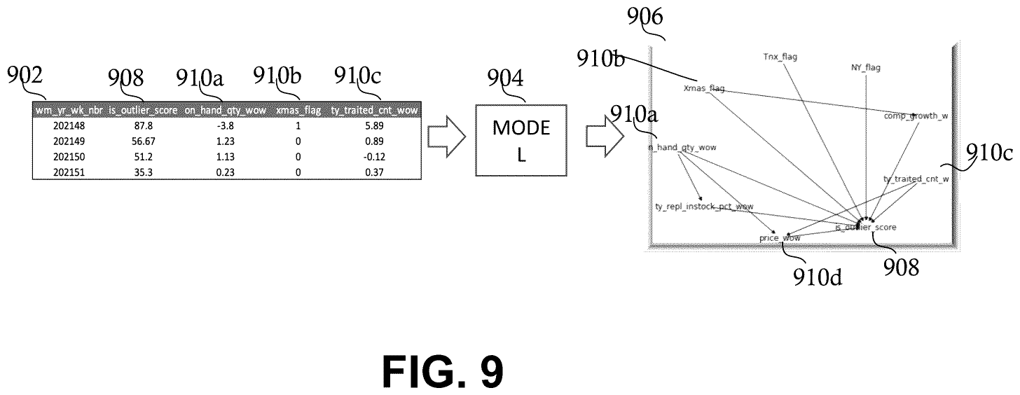

Referring to FIG. 9, as illustrated in chart 902, causal attribution engine 304 may retrieve anomaly scores (e.g., outlier score) for each week for a product or product category. For each anomaly of chart 902, causal attribution engine 304 may generate an E value for a plurality of attributes. In some embodiments, one or more attributes are analyzed week over week, such as onhand or traited count. For certain attributes, such as Holidays (e.g., Christmas, Thanksgiving), the attribute is not analyzed week over week.

Causal attribution engine 304 may generate linkage map 906 (or causal graph) by applying model 904 to the one or more anomalies (e.g., anomaly 908) and attributes (e.g., 910a, 910b, 910c, etc.) of chart 902. In some embodiments, linkage map 906 maps one or more attributes (e.g., 910a, 910b, 910c, etc.) to one or more extreme anomalies (e.g., anomaly 908) identified in chart 902 based on the causal estimation value (E) and the refutal p-value (R). In some embodiments, causal attribution engine 304 utilizes one or more models (e.g., model 904) to determine linkages between anomalies and the attributes. For example, causal attribution engine 304 may utilize methods such as NOTEARS (Non-combinatorial Optimization via Trace Exponential and Augmented Lagrangian for Structure learning) to determine linkages between one or more attributes and the one or more extreme anomalies. In some embodiments, causal attribution engine 304 utilizes raw features for causal discovery and does not utilize the transformed binary treatments. Linkage map 906 may map one more attributes to each other and to the one or more anomalies. In some embodiments, the links generated between the one or more anomalies and attributes, as presented in linkage map 906, is stored within database 116.

In some embodiments, linkage map 906 is generated for a desired week. For example, for a desired week, anomaly engine 302 generates an anomaly score associated with an anomaly, which is based on the performance of one or more products or product categories. Causal attribution engine 304 may generate or identify causal factors or attributes associated with the anomaly. Causal attribution engine 304 may generate a causal estimation value (E) and a refutal p-value (R) for each attribute. Based on the causal estimation value (E) and the refutal p-value (R), causal attribution engine 304 may generate a linkage map linking the attributes to the anomaly based on the causal estimation value (E) and the refutal p-value (R).

In some embodiments, an anomaly score for an anomaly for a specific product or product category is determined per week. Causal attribution engine 304 may generate the causal estimation value (E) and the refutal p-value (R) per week for the anomaly. Over several weeks, multiple anomaly scores, the causal estimation values (E), and the refutal p-value (R) may be generated for the specific product or product category for each week. Causal attribution engine 304 may generate a linkage map linking the attributes to the anomaly based on the causal estimation value (E) and the refutal p-value (R) for one or more weeks.

In some embodiments, the linkages of the linkage map are user configurable. For example, causal attribution engine 304 may generate linkage map 906 and present linkage map 906 to a user via a user interface. The user may remove, add, or modify links between the attributes and anomaly.

In some embodiments, causal attribution engine 304 provides insights or links between the attributes and anomalies. For example, an anomaly may be detected by anomaly engine 302 due to a deviation in the performance of a product. Causal attribution engine 304 may be configured to identify attributes that are linked and associated with the deviation in the performance of the product (e.g., the anomaly). In some embodiments, causal attribution engine 304 retrieves from one or more databases (e.g., database 116) causal analysis data associated with the attribute and links the causal analysis data to the anomaly using one or more models (e.g., machine learning models, statistical algorithms, etc.). For example, an anomaly may indicate that sales of the product decreased and causal attribution engine 304 may identify an attribute of weather associated with the anomaly. Causal attribution engine 304 may obtain additional data associated with the attribute of weather, such as temperature, humidity, wind, precipitation, etc. Using the additional data, causal attribution engine 304, via one or more models, may generate causal analysis data linking the attribute of weather to the anomaly based on the additional data. For example, the causal analysis data may indicate that due to low temperatures and high precipitation, the sales of the product decreased resulting in the anomaly.

In some embodiments, causal attribution engine 304 is configured templatize the attributes based on textual data stored within database 116. For example, database 116 may include textual data associated with each type of attribute and may be modified based on causal attribution engine 304 based on the identified anomaly. The modified textual data may be presented to the user as an insight (e.g., insight 1226 of user interface 1202). In some embodiments, the textual data is generated by causal attribution engine 304 using one or more models. The attribute and the performance of the product or product category (e.g., deviation in performance) may be inputted into the model to generate the textual data. The textual data may be a causal relationship between the attribute and the anomaly. For example, for an attribute of weather, causal attribution engine 304 may receive from one or more databases data associated with weather and input that data into the model along with the attribute and the anomaly to generate textual data. The textual data may provide a cause for the anomaly based on the attribute.

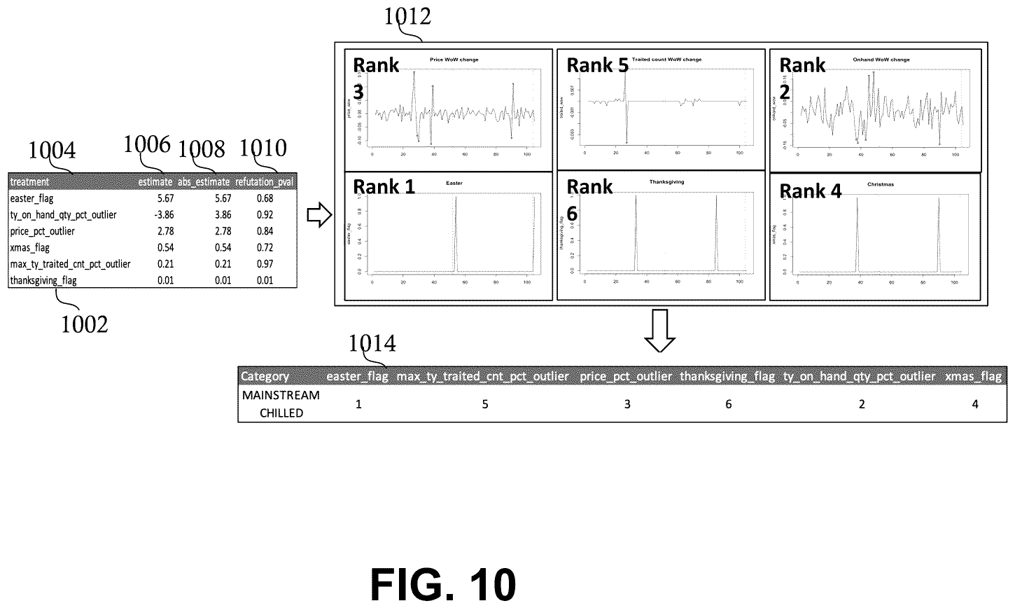

Referring to FIG. 10, casual attribution engine 304 is configured to rank the one or more attributes that are identified as having a causal impact on the performance of the product or product category. For example, once the causal estimation values (E), and the refutal p-value (R) are generated for each attribute, causal attribution engine 304 may rank the attributes based on their respective causal estimation values (E). In some embodiments, causal attribution engine 304 ranks the attributes based on the absolute value of their respective causal estimation values (E). In some embodiments, causal attribution engine 304 filters out attributes that have R value below a predetermined threshold, indicating that the E value associated with the R value below the predetermined threshold is not statistically significant. Causal attribution engine 304 may rank (e.g. prioritize) the E values that have not been filtered out as having an R value below the predetermined threshold.

Causal attribution engine 304 may group the E value and R value for each attribute associated with an anomaly. For example, as shown in chart 1002, for an identified anomaly, casual attribution engine 304 generates a plurality of attributes (e.g., plurality of attributes 1004), the E value for each of the plurality of attributes (e.g., E value column 1006), the absolute value of the E value for each of the plurality of attributes (e.g., absolute value E value column 1008), and the R value for each of the plurality of attributes (e.g., R value column 1010).

Based on the absolute value for the E value for each attribute (e.g., column 1008), casual attribution engine 304 may generate a ranking of each attribute that is associated with the identified anomaly (e.g., the anomaly identified by anomaly engine 302). For example, as illustrated in graphic 1012, causal attribution engine 304 may rank each attribute based on the absolute value of their respective E value. In some embodiments, the ranking is determined based on the absolute value of the E value.

Causal attribution engine 304 may output a ranking or prioritization for the product or product category. For example, as shown in chart 1014, for a product category of MAINSTREAM CHILLED, causal attribution engine 304 generates a ranking of attributes that are identified by one or more models as having an impact in the performance of the product category of MAINSTREAM CHILLED causing anomalies (e.g., deviations in the performance), which are identified by anomaly engine 302. In the above example for the product category of MAINSTREAM CHILLED, Easter is identified as having the greatest impact on the performance and thus a primary or main cause of the identified anomaly. Further, onhand is identified as having the second greatest impact on the performance and thus a secondary cause of the identified anomaly. Price is identified as having the third greatest impact on the performance and thus a tertiary cause of the identified anomaly. Christmas, traited store count, and Thanksgiving are identified as having the fourth, fifth, and sixth greatest impact on the performance, respectively, and thus are identified as not being a main contributor to the cause of the anomaly.

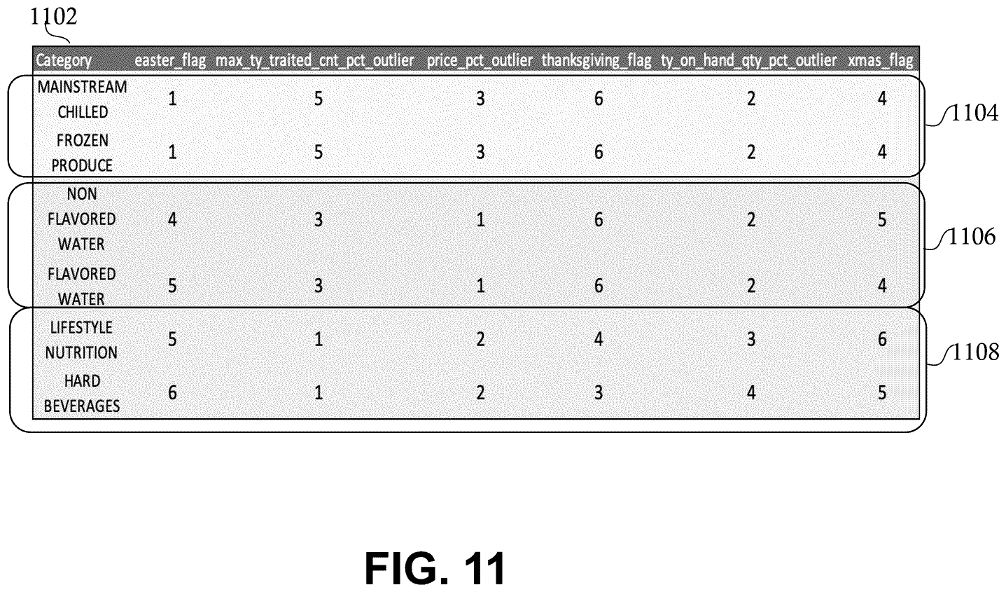

Referring to FIG. 11, CA generator 102 may include a similarity engine (e.g., similarity engine 306 of FIG. 3). Once the E values and R values are determined and the attribute are ranked based on the absolute value of the E values, similarity engine 306 may identify similar products or product categories based on the rankings of the attributes. For example, anomaly engine 302 may identify anomalies for a plurality of products and/or product categories and casual attribution engine 304 may generate attributes (e.g., causal factors) for the identified anomalies for each of the plurality of products and/or product categories and rank the attributes, based on the E value, for each of the plurality of products and/or product categories. In other words, CA generator 102 may determine anomalies and attributes/casual factors for a plurality of products and product categories, rank the attributes for each product or product category, and store the data in database 116.

Similarity engine 306 may obtain from database 116, rankings of attributes for each product and/or product category. Similarity engine 306 may be configured to cluster similar products based on the ranked attributes. Grouping items/products with similar root causes (e.g., attributes) help suppliers and retailers plan corrective actions in response to deviations in performance (e.g., anomalies).

With continued reference to FIG. 11, similarity engine 306 may generate rankings for a plurality of products or product categories. In some embodiments, similarity engine 306 clusters or groups similar products or product categories together based on similar attribute rankings. For example, as illustrated in chart 1102, similarity engine 302 may receive rankings (e.g., from causal attribution engine 304) for each product category. In some embodiments, similarity engine 306 receives rankings for individual products and groups them together into a product category.

Similarity engine 306 may analyze the rankings of a product category and identify another product category having similar rankings. For example, as illustrated in chart 1102, similarity engine 306 may identify that MAINSTREAM CHILLED has identical attribute rankings as FROZEN PRODUCE and may group them together into cluster 1104. Further, similarity engine 306 may identify that NON FLAVORED WATER has substantially similar attribute rankings as FLAVORED WATER and may group them together into cluster 1106. Similarity engine 306 may identify that LIFESTYLE NUTRITION has substantially similar attribute rankings as HARD BEVERAGES and may group them together into cluster 1106. In some embodiments, product categories grouped into a cluster by similarity engine 306 are similar in terms of the causal attributions for product performance within the product categories. Alternatively, product categories grouped into different clusters by similarity engine 306 are different in terms of the causal attributions for product performance within the product categories.

In some embodiments, similarity engine 306 determines whether product or product categories are similar based on the top attribute rankings. For example, similarity engine 306 may analyze the top three attributes for a first product category and may identify a second product category has having the same top three attributes. Similarity engine 306 may cluster and group the first product category with the second product category. In some embodiments, the top three attributes must have the same ranking between the first product category and the second product category. Alternatively, the top three attribute rankings may have different rankings for the top three, but may have the same attributes in the top three.

Similarity engine 306 may be configured to identify similar products or product categories to allow a user to proactively address performance issues with multiple products. For example, multiple product or product categories may have the same cause resulting in deviations in their performance. Similarity engine 306 may identify one or more products or product categories that have causes similar to the product or product category for with analysis was initially request by the user.

In some embodiments, similarity engine 306 utilizes one or more models to identify similar product or product categories based on attribute rankings. For example, similarity engine 306 may cluster similar product or product categories based on attribute rankings using K-modes algorithm. Similarity engine 306 may use one or more trained models to identify similar product or product categories based on attribute rankings. In some embodiments, the output of the one or more trained models is a similar product or product category. The similar product or product category may be stored within a training data set to further refine and train the one or more models.

The database 116 may also store machine learning model data (e.g., training data) identifying and characterizing one or more machine learning models and related data for identify similar products or product categories based on attribute rankings.

In some embodiments, similarity engine 306 is configured to determine a similarity score between one or more product or product categories based on attribute rankings. Similarity engine 306 may be trained based on one or more of the following metrics: correlation, L1 norm, L2 norm, dynamic time warping metric, etc. For example, the similarity model 392 may be used to generate a similarity matrix, each element of which is a similarity score for a corresponding pair of two product or product categories. The similarity matrix includes all similarity scores for all possible groups of product or product categories.

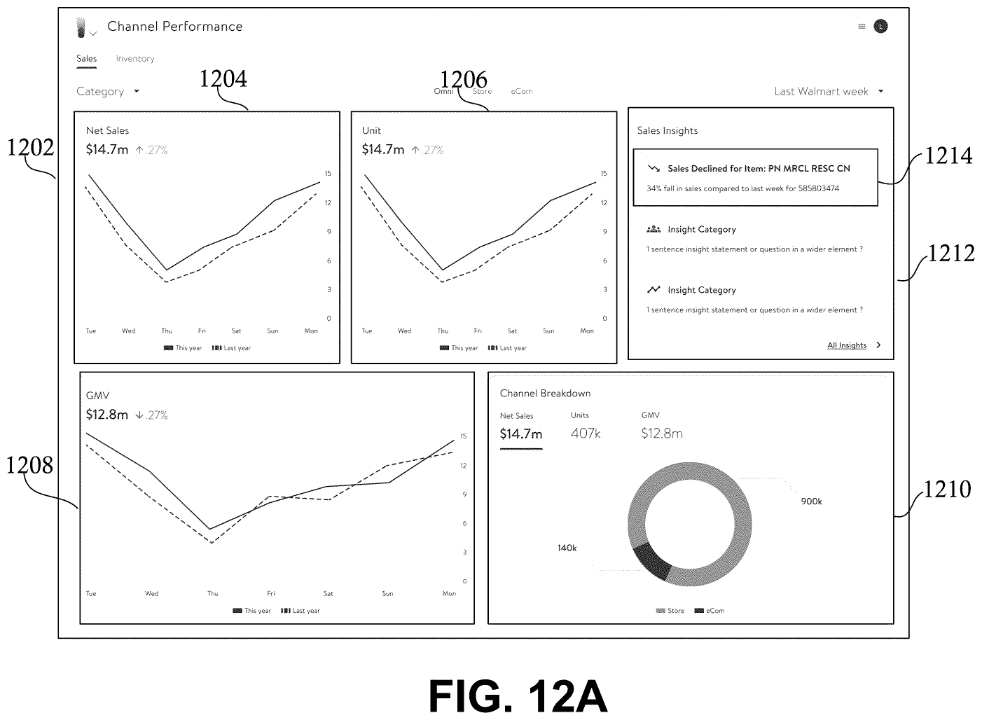

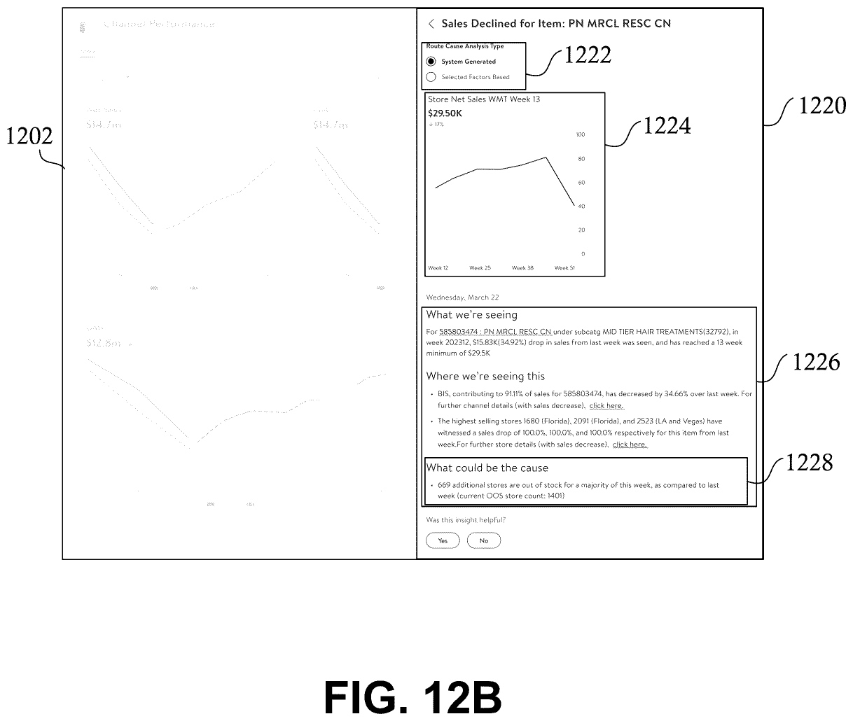

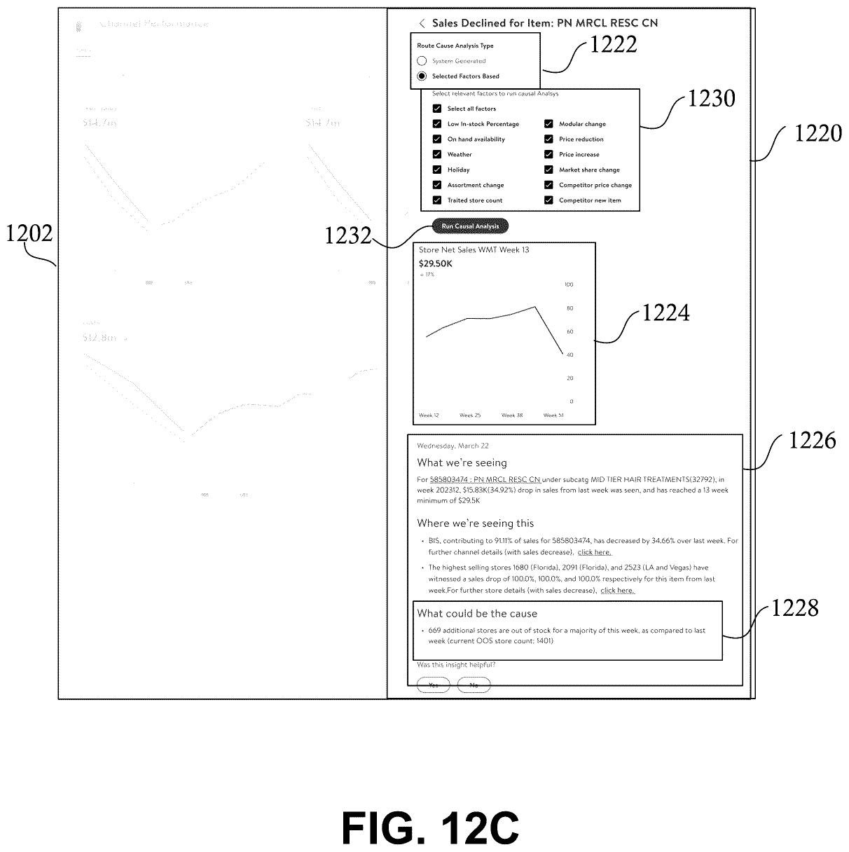

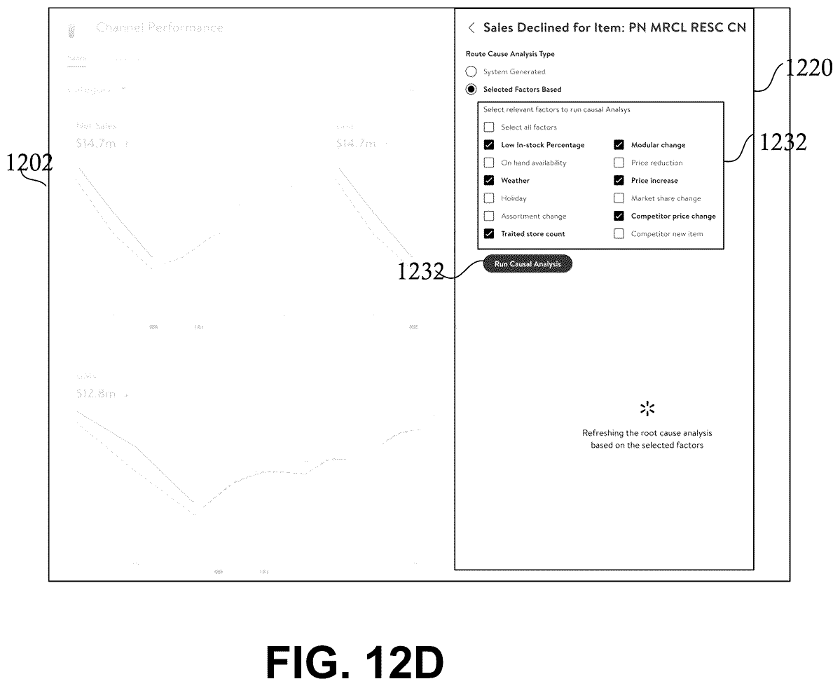

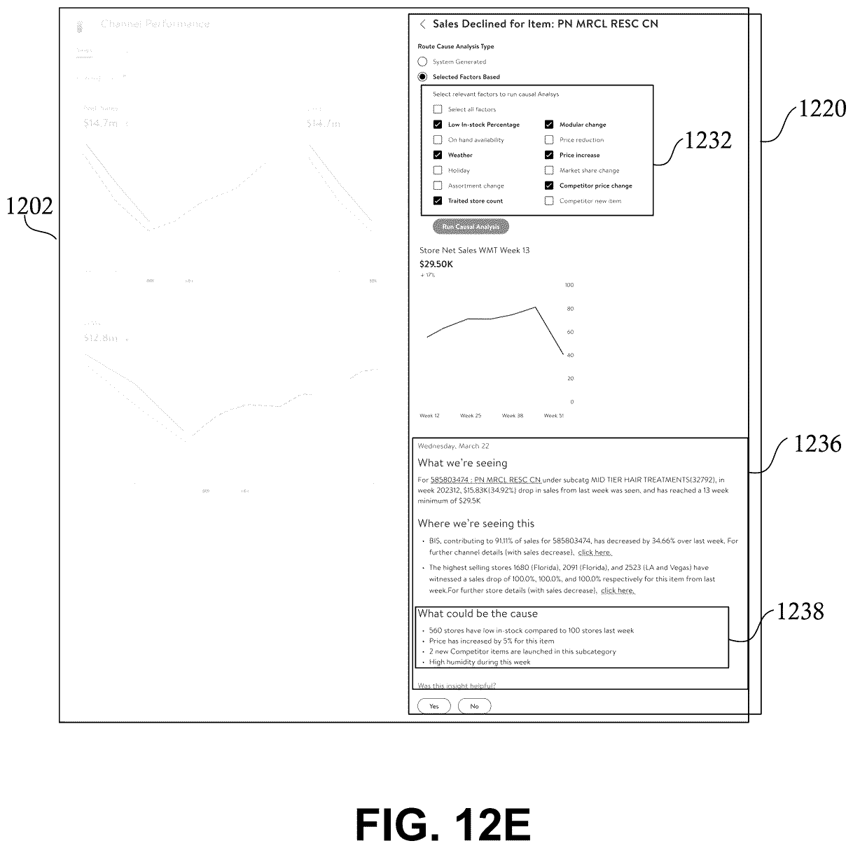

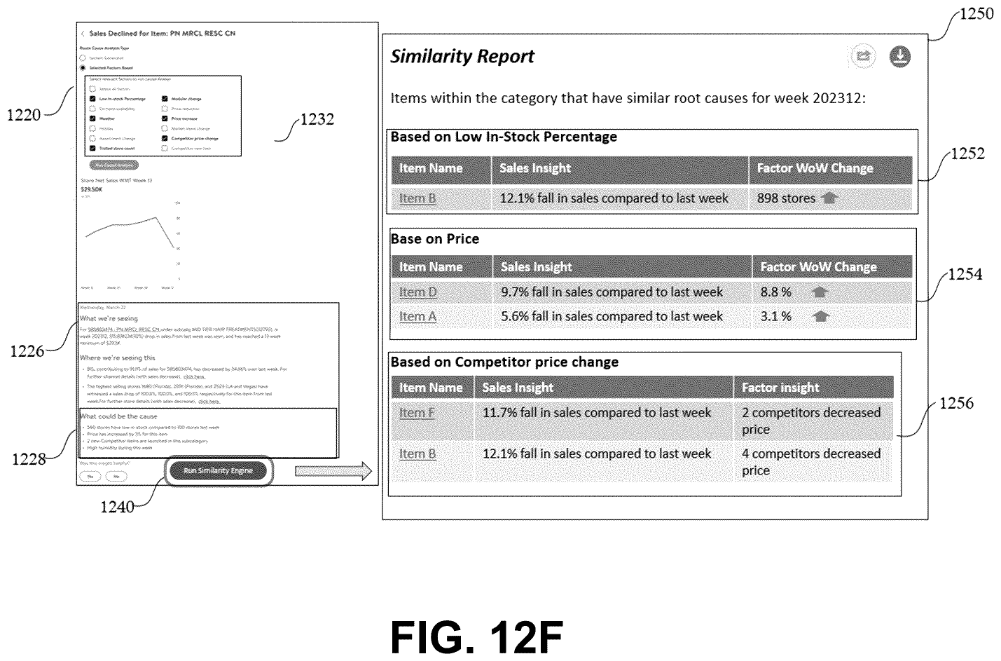

Referring to FIGS. 12A-12F, user interface 1202 may be provided to the user or retailer. In some embodiments, CA generator 102 is configured to render user interface 1202 on a display screen. User interface 1202 may be configured to allow a user to interact with one or more business metrics, product data, selection of anomalies, insights pertaining to the attributes (e.g., causes), etc. User interface 1202 may provide to the user information regarding the performance of one or more products or product categories. In some embodiments, user interface 1202 provides to the user data and graphics associated with one or more identified anomalies, attributes associated with the anomalies, insights into the attributes, and/or similar products based on the attributes.

Referring to FIG. 12A, a user may use user interface 1202 to view business metrics associated with a first product category. User interface 1202 may include graphics 1204, 1206, 1208, and 1210 showing various business metrics of the first product category. For example, graphic 1204 may include a graph illustrating the net sales of the first product category. Graphic 1206 may include a graph illustrating inventory or number of units of items of the first product category. Graphic 1208 may include the gross merchandise value (GMV) of the first product category. Graphic 1210 may include illustrations representing breakdown of the above various business metrics (e.g., net sales, units, GMV). In some embodiments, user interface 1202 provides a user with graphic 1212 representing various insights associated with the business metrics of the first product category. For example, CA generator 102 provide analysis of the business metrics, such as decreasing net sales of the first product category based on graphic 1212.

In some embodiments, a user may interact with and select graphic 1214 to view additional information and data regarding insights into various business metrics. Graphic 1214 may be interactable to allow a user to view deviations in the performance of the first product category and modify various parameters to predict and prevent deviations in performance of the first product category and/or other product categories.

Referring to FIG. 12B, upon selection of graphic 1214, user interface 1202 may render screen 1220. Screen 1220 may be a pop-out or another screen displayed on user interface 1202. Screen 1220 may include cause analysis selection 1222, performance graphic 1224, and performance insights 1226. Causal analysis selection 1222 may include options pertaining to “System Generated” and “Selected Factors Based”. User selection of “System Generated” results in CA generator 102 automatically identifying one or more anomalies in the performance of the first product category, identifying attributes associated with the one or more anomalies, retrieving information associated with the identified attributes, ranking the identified attributes (e.g., based on E values and R values), and providing similar products based on the identified and ranked attributes.

In some embodiments, upon selection of “System Generated” by a user, user interface 1202 may render insights 1226, which may include causal analysis 1228. Causal analysis 1228 may provide additional information regarding the cause of the anomaly or deviation in performance of the first product category based on the attributes identified by CA generator 102 (e.g., causal attribution engine 304). In some embodiments, CA generator 102 retrieves causal analysis data from database 116 and/or external databases. The causal analysis data may be data that links the attribute to the anomaly or deviation in the performance of the first product category.

User selection of “Selected Factors Based” may allow the user to selected one or more attributes, retrieving information associated with the selected attributes, and provide similar products based on the selected attributes. In some embodiments, selection of “System Generated” initiates an automated process carried about by CA generator 102 to identify attributes associated with the one or more anomalies, retrieve information associated with the identified attributes, rank the identified attributes (e.g., based on E values and R values), and/or provide similar products based on the identified and ranked attributes.

Referring to FIG. 12C, selection of “Selected Factors Based” provides the user with one or more attributes which may be selected. For example, selection of “Selected Factors Based” may cause user interface 1202 to render selection matrix 1230, which may include a plurality of attributes that are configured to be selectable by a user. The one or more attributes may include Low In-Stock Percentage, On hand availability, Weather, Holiday, Assortment change, Traited store count, Modular change, Price reduction, Price increase, Market share change, competitor price change, and/or competitor new item. A user may select one or more attributes from selection matrix 1230. The one or more attributes may be causes for deviation in performance (e.g., decrease in sales or other business metrics). Upon selection of one or more attributes, a user may select selection matrix 1232 to run a causal analysis via causal attribution engine 304.

Referring to FIG. 12D, upon selection of selection matrix 1232, user interface 1202 may refresh to provide a root cause analysis based on the attributes selected by the user form selection matrix 1230.

Referring to FIG. 12E, upon completion of the refresh, user interface 1202 may render updated insights 1236 and updated causal analysis 1238. Update causal analysis 1238 may provide causal analysis data to the user regarding the specific attributes selected from selection matrix 1232. Updated causal analysis 1238 may provide cause of the anomaly based on the selected attributes.

Referring to FIG. 12F, user interface 1202 may be configured to provide via screen 1220 similar products based on the causal analysis and attributes. For example, user interface 1202 may provide user, via screen 1220, element 1240. Selection of element 1240 may cause CA generator 102, via similar engine 306, to generate similar product or product categories based on the attributes selected by the user or identified by the system (e.g., CA generator 102).

Upon selection of element 1240, user interface 1202 may render on screen 1220 graphic 1250 displaying similar products identified via similarity engine 306. In some embodiments, user interface 1202 may render similar products based on each attribute that is either selected by the user or identified by CA generator 102 (e.g., system generated). Screen 1220 may provide similar products identified by similar engine 306 based on rankings of attributes generated by causal attribution engine 304 as discussed above. For example, for the attribute of “Low In-Stock Percentage” CA generator 102 (e.g., similarity engine 306) may identify similar product 1252, which is similar to first product category. For the attribute of “Price” CA generator 102 (e.g., similarity engine 306) may identify similar product 1254, which is similar to first product category. For the attribute of “Competitor Price Change” CA generator 102 (e.g., similarity engine 306) may identify similar product 1256, which is similar to first product category. For each identified similar product 1252, 1254, 1256, user interface may provide additional insight and factor insights (e.g., sales insights) based on the causal analysis data generated by causal attribution engine 304. In some embodiments, the sales insights are derived using the anomaly flag and it is textually representing the week over week change in the product's performance with respect to a reference week.

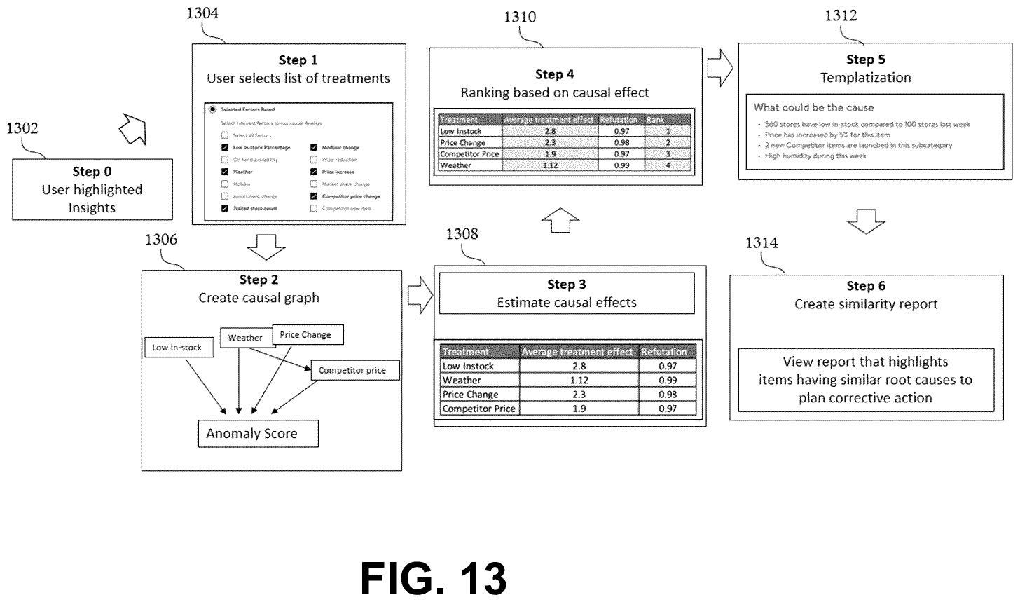

FIG. 13 is a flowchart illustrating an exemplary method for controlling product allocation in response to market variations based on generating causal analysis. At operation 1302, a user may select whether they want the system (e.g., CA generator 102) to generate attributes or whether the user selects specific attributes associated with a product. For example, a user can choose to add a specific week's performance in the historical product data as an anomaly to generate the subsequent causal attribution factors. In another example, a user can remove a system generated anomaly from subsequent analysis. These are examples of user highlighted insights. At operation 1304, a user may select one or more treatments (e.g., attributes) associated with a deviation in the performance of a first product. At operation 1306, CA generator 102 via causal attribution engine 304 may generate a causal graph providing links between the attributes and the anomaly and/or anomaly score. At operation 1308, CA generator 102 may generate causal estimation values (E) and the refutal p-values (R) for each attribute. At operation 1310, causal attribution engine 304 may rank the attributes based on the causal estimation values (E). At operation 1312, causal attribution engine 304 may templatize the attributes based on textual data stored within database 116. The textual data may be used to provide the user with insights associated with linking the attribute to the anomaly.

At operation 1314, CA generator 102 via similarity engine 306 may generate one or more similar products that are similar to the product. Similarity engine 306 may identify and generate a report for screen 1220 based on the ranking of attributes at operation 1310.

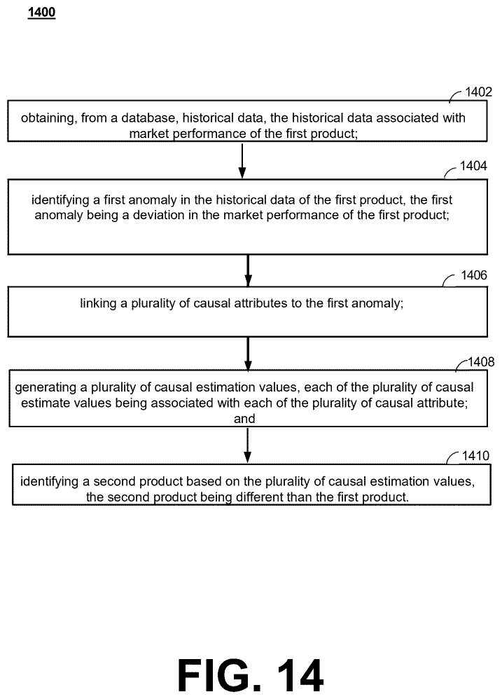

FIG. 14 is a flowchart illustrating an exemplary method 1400 for controlling product allocation in response to market variations, in accordance with some embodiments of the present teaching. In some embodiments, the method 1400 can be carried out by one or more computing devices, such as the CA generator 102 of FIG. 1. Beginning at operation 1402, historical data is stored in a database. The historical data may be associated with market performance of a first product. At operation 1404, CA generator 102 is configured to identifying a first anomaly in the historical data of the first product, the first anomaly being a deviation in the market performance of the first product. At operation 1406, CA generator 102 is configured to link a plurality of causal attributes to the first anomaly. At operation 1408, CA generator 102 is configured to generate a plurality of causal estimation values. In some embodiments, each of the plurality of causal estimate values is associated with each of the plurality of causal attribute. At operation 1410, CA generator 102 is configured to identify a second product based on the plurality of causal estimation values. In some embodiments, the second product is different than the first product.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database storing historical data associated with a first product;
a computing device comprising at least one processor in communication with the database, the computing device being configured to:
obtain, from the database, the historical data, the historical data associated with market performance of the first product;
identify a first anomaly in the historical data of the first product, the first anomaly being a deviation in the market performance of the first product;
link a plurality of causal attributes to the first anomaly;
generate a plurality of causal estimation values, each of the plurality of causal estimate values being associated with each of the plurality of causal attribute; and
identify a second product based on the plurality of causal estimation values, the second product being different than the first product.

2. The system of claim 1, wherein the computing device is further configured to:
generate a plurality of causal refutal values, each of the plurality of causal refutal values being associated with each of the plurality of causal estimating values and each of the plurality of causal attributes;
filter the plurality of causal attributes based on a comparison of each of the plurality of causal refutal values to a predetermined refutal threshold to generate a plurality of filtered causal attributes; and
rank the plurality of filtered causal attributes based on their respective plurality of causal estimation values.

3. The system of claim 1, wherein the computing device is further configured to:
compare the historical data to a predetermined threshold to identify the first anomaly; and
generate an anomaly score based on the comparison.

4. The system of claim 3 wherein the computing device is further configured to:
compare the anomaly score to a predetermined anomaly threshold; and
transform the anomaly score to a binary representation based on the comparison of the anomaly score to the predetermined anomaly threshold.

5. The system of claim 1 wherein the computing device is further configured to:
retrieve, from the database, a plurality of products;
generate a ranking of a plurality of causal attributes of each of the plurality of products;
compare the ranking of the plurality causal attributes for each of the plurality of products to one another; and
generate a plurality of similar products based on the comparison, the plurality of similar products being a subset of the plurality of products, each similar product in the plurality of similar products having an identical ranking of causal attributes.

6. The system of claim 1 wherein the computing device is further configured to:
render, on a user interface, at least one insight related to one causal attribute of the plurality of causal attributes, the insight including textual data linking the one causal attribute to the first anomaly.

7. The system of claim 1 wherein the computing device is further configured to:
render, on a user interface, a selection matrix configured to receive an input from a user, the selection matrix including a selection of the plurality of causal attributes; and
in response to the input from the user, generate at least one insight related to one causal attribute of the plurality of causal attributes, the insight including textual data linking the one causal attribute to the first anomaly.

8. The system of claim 1 wherein the computing device is further configured to:
render, on a user interface, an interactive graphic including the first anomaly;
in response to an input from a user, modify the interactive graphic to include a second anomaly;
aggregate the first anomaly and the second anomaly to create a set of anomalies; and
link the plurality of causal attributes to the set of anomalies.

9. The system of claim 1 wherein the plurality of causal estimation values are generated using double machine learning.

10. The system of claim 1 wherein the plurality of causal attributes are linked to the first anomaly using a Non-combinatorial Optimization via Trace Exponential and Augmented Lagrangian for Structure learning algorithm.

11. A computer-implemented method, comprising:
obtaining, from a database, historical data, the historical data associated with market performance of a first product;
identifying a first anomaly in the historical data of the first product, the first anomaly being a deviation in the market performance of the first product;
linking a plurality of causal attributes to the first anomaly;
generating a plurality of causal estimation values, each of the plurality of causal estimate values being associated with each of the plurality of causal attribute; and
identifying a second product based on the plurality of causal estimation values, the second product being different than the first product.

12. The method of claim 11 further comprising
generating a plurality of causal refutal values, each of the plurality of causal refutal values being associated with each of the plurality of causal estimating values and each of the plurality of causal attributes;
filtering the plurality of causal attributes based on a comparison of each of the plurality of causal refutal values to a predetermined refutal threshold to generate a plurality of filtered causal attributes; and
ranking the plurality of filtered causal attributes based on their respective plurality of causal estimation values.

13. The method of claim 11 further comprising:
comparing the historical data to a predetermined threshold to identify the first anomaly; and
generating an anomaly score based on the comparison.

14. The method of claim 13 further comprising:
comparing the anomaly score to a predetermined anomaly threshold; and
transforming the anomaly score to a binary representation based on the comparison of the anomaly score to the predetermined anomaly threshold.

15. The method of claim 11 further comprising:
retrieving, from the database, a plurality of products;
generating a ranking of a plurality of causal attributes of each of the plurality of products;
comparing the ranking of the plurality causal attributes for each of the plurality of products to one another; and
generating a plurality of similar products based on the comparison, the plurality of similar products being a subset of the plurality of products, each similar product in the plurality of similar products having an identical ranking of causal attributes.

16. The method of claim 11 further comprising:
rendering, on a user interface, at least one insight related to one causal attribute of the plurality of causal attributes, the insight including textual data linking the one causal attribute to the first anomaly.

17. The method of claim 11 further comprising:
rendering, on a user interface, a selection matrix configured to receive an input from a user, the selection matrix including a selection of the plurality of causal attributes; and
in response to the input from the user, generating at least one insight related to one causal attribute of the plurality of causal attributes, the insight including textual data linking the one causal attribute to the first anomaly.

18. The method of claim 11 further comprising:
rendering, on a user interface, an interactive graphic including the first anomaly;
in response to an input from a user, modifying the interactive graphic to include a second anomaly;
aggregating the first anomaly and the second anomaly to create a set of anomalies; and
linking the plurality of causal attributes to the set of anomalies.

19. The method of claim 11, wherein the plurality of causal attributes are linked to the first anomaly using a Non-combinatorial Optimization via Trace Exponential and Augmented Lagrangian for Structure learning algorithm.

20. A non-transitory computer readable medium having instructions stored thereon, wherein the instructions, when executed by at least one processor, cause at least one device to perform operations comprising:
obtaining, from a database, historical data, the historical data associated with market performance of a first product;
identifying a first anomaly in the historical data of the first product, the first anomaly being a deviation in the market performance of the first product;
linking a plurality of causal attributes to the first anomaly;
generating a plurality of causal estimation values, each of the plurality of causal estimate values being associated with each of the plurality of causal attribute; and
identifying a second product based on the plurality of causal estimation values, the second product being different than the first product.
